(19) United States
(12) Patent Application Publication
(10) Pub. No.: US 2008/0126921 A1
(43) Pub. Date: May 29, 2008

(54) METHOD AND COMPUTER FOR DISPLAYING PRESET INFORMATION

(76) Inventors: Jian Chen, Beijing (CN); Xiu Hua Huang, Beijing (CN); Yuan Li, Beijing (CN); Wenjun Wang, Beijing (CN)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 11/945,600

(22) Filed: Nov. 27, 2007

(30) Foreign Application Priority Data
Nov. 29, 2006 (CN) 2006 10162951.4

(51) Int. Cl. G06F 3/14; G06F 15/177

(52) U.S. Cl. 715/200; 713/2

(57) ABSTRACT

The present invention provides a method for a computer displaying user preset information and a computer using the method. The method comprises powering on the computer, and the computer executing basic input output system power on self test; executing boot loader started by an operating system to load a kernel of the operating system to the computer; performing the kernel bootstrap started by the operating system; the kernel of the operating system starting the startup section of the fourth phase of the operating system boot up process; the computer displaying user preset information; and completing the fourth phase of the operating system boot up process. According to the present invention, the user may use the displayed information when the operating system is starting services.

### CROSS REFERENCES TO RELATED APPLICATIONS

This application is related to Chinese Patent Application No. 200610162951.4, filed Nov. 29, 2006.

### FIELD OF THE INVENTION

The present invention relates to the technology for displaying information to a user, and more particularly, relates to a method and computer for displaying preset information.

### BACKGROUND OF THE INVENTION

Computers are now becoming a necessity in the daily life of people from various backgrounds. Whether users are aware or not of the system boot up process, they have to experience it, i.e. they have to wait until it completes to start user applications before working on it. The system boot up process may take a couple of minutes and during this period of time, users can do nothing but wait. Although the advance of technology and changing boot configuration (only by those who have the skills) can speed up the boot process, a basic boot up process will always consist of a sequence of stages which takes time. The typical boot up screen is either a graph with OS manufacturer's logo or lines of tasks performing printouts for showing the process status of tasks. Users may get bored by viewing the progress bar's while waiting and they probably don't need the daily reminder that they are running a certain operating system.

### SUMMARY OF THE INVENTION

For the shortcoming of the existing technology, users need to utilize that period of time to do something meaningful. This invention utilizes system booting time to display information that will only be displayed after booting up the system.

Currently the primary operating systems in the market, such as Widows, Linux, AIX, don't have this mechanism. These operating systems display the OS logos, progress bars or print a list of tasks ongoing. This information may not be required by a general user every day.

The present invention provides a method for a computer displaying user preset information, including powering on the computer, and the computer executing basic input output system power on self test; executing boot loader to load a kernel of the operating system to the computer; performing the kernel bootstrap started by the operating system; the kernel of the operating system starting the startup section of fourth phase of the operating system boot up process; the computer displaying user preset information; and completing the fourth phase of the operating system boot up process.

The present invention also provides a computer for displaying user preset information, including power on self test means, for powering on the computer, and enabling the computer to execute basic input output system power on self test; boot loader means, for executing boot loader to load the kernel of the operating system to the computer; kernel bootstrap means, for performing kernel bootstrap started by the operating system; startup section means, for the kernel of the operating system starting the startup section of fourth phase of the operating system boot up process; displaying means, for displaying user preset information; and means for completing the fourth phase of the operating system boot up process.

The computer according to the present invention could start to display preset information for a user after completing the first three phases of the operating system boot up. Thus, the preset information is displayed to the user at the startup section of the fourth phase of the operating system boot up process. The user can utilize the information when the operating system is completing the fourth phase. For example, the user may use the displayed information when the operating system is starting services.

### BRIEF DESCRIPTION OF THE DRAWINGS

FIG. 1 is a flowchart according to one embodiment of the present invention.

FIG. 2 is a flowchart according to another embodiment of the present invention.

### DETAILED DESCRIPTION

The present invention provides a method and apparatus for of displaying non-booting information during the later part of a computer operating system boot up process. The displayed information can be user's To Do List, personal memo, calendar information, pure text information, information with picture or other customizable information.

Generally, a computer operating system boot up process consists of four stages: BIOS POST phase, boot loader phase, kernel bootstrap phase and the fourth phase (or initialization phase). The fourth phase for Linux is init phase. The fourth phase for Windows includes the phase of running SMSS and starting services after the Kernel bootstrap phase. The first three stages usually last for less than half a minute in total. The real time-consuming part is the last stage, i.e. the fourth phase (e.g. init phase), generally requiring about 1.5 to several minutes. During the fourth phase, the system begins to create first user mode process. The process will do some system initialization work and start services. The present invention uses this fourth phase (initialization phase) to display desired information. This provides user with useful information to start work before the system completing boot up.

For example, a user arrives at his office at 8:50, and powers on his PC. In the first half minute, the computer will carry out the first three phrase of the operating system boot up process. Then, the computer may display preset information which was set before user last powering off the computer. For example, the information says “You have a meeting at meeting room 1 9:00 AM”. Seeing the information, the user might start to prepare for the meeting, or consider the content of the meeting.

Operating systems usually boot up in a similar way. The following will take Linux (Fedora Core 5) and Windows on a PC as an example to describe the invention. A person skilled in the art can understand that the method can also be applied to other operating systems.

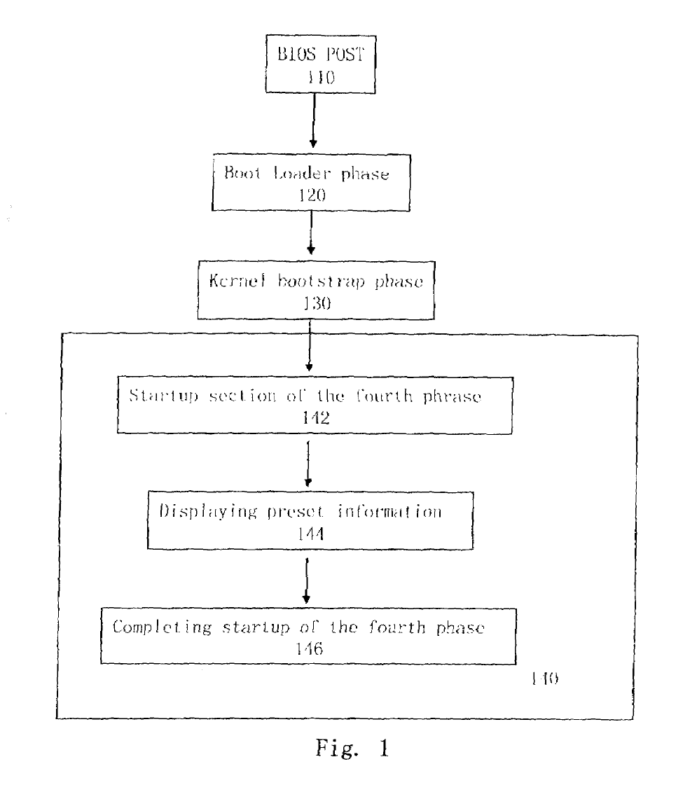

FIG. 1 is a flowchart according to one embodiment of the present invention. At step 110, a computer starts to boot up when power is on, BIOS POST phase starts first. The BIOS in the computer executes POST (Power On Self Test) to check RAM, disk drives, peripheral devices and other hardware components in the computer.

After BIOS POST phase, the computer starts Boot Loader phase 120. Boot loader is stored in MBR (Master Boot Record). The boot loader is NTLDR for Windows; and it is Grub/LILO for Linux. Generally, boot loader will do: initial Boot Loader Phase, Operating System selection, hardware detection and configuration selection.

After Boot Loader phase, the computer starts kernel bootstrap phase 130. In this phase, a kernel is loaded into memory and executed. The kernel is NTOSKRNL.EXE for Windows and a specific version kernel for Linux. The main task of kernel bootstrap is to initialize memory data structure, interrupts, prepare memory areas for cache, and initialize paged and non-paged pools of memory. For example, in the kernel bootstrap phase, Linux will carry out: decrypt kernel code and kernel initialization. The kernel initialization comprise: initialize hardware related with system architecture, initialize kernel page table, initialize kernel module, cache, root file system, file cache and signal queue, etc.

For windows, hardware device drivers are initialized during this kernel bootstrap phase 130. All executive subsystems are reinitialized in the following order: 1) Object Manager, 2) Executive, 3) Microkernel, 4) Security Reference Monitor, 5) Memory Manager, 6) Cache Manager, 7) LPCs (Local Procedure Calls), 8) I/O Manager and 9) Process Manager.

After the computer finishes the first three phases, and after kernel bootstrap phase 130, the kernel of the computer operating system starts the fourth phase 140 of the boot up, and the kernel creates a first user mode process which leads the tasks of this fourth phase 140. In FIG. 1, fourth phase 140 of the operating system bootup includes the operating system kernel starting the startup section 142 of fourth phrase 140, displaying preset information step 144 and completing startup step 146 of fourth phase 140. Wherein, the step 142 of fourth phrase 140 further includes creating a first user mode process by the Kernel. The completing startup step 146 further includes startup services. According to a preferred embodiment of the present invention, displaying the preset information would better be carried out before starting services. Thus, the user can utilize the information when the operating system is starting services. Wherein, completing startup step 146 might further include prompting a user to login to the operating system after starting services.

Wherein, displaying preset information step might start at different time of fourth phase 140, and this determines how much time is used to display required information before system finish boot up.

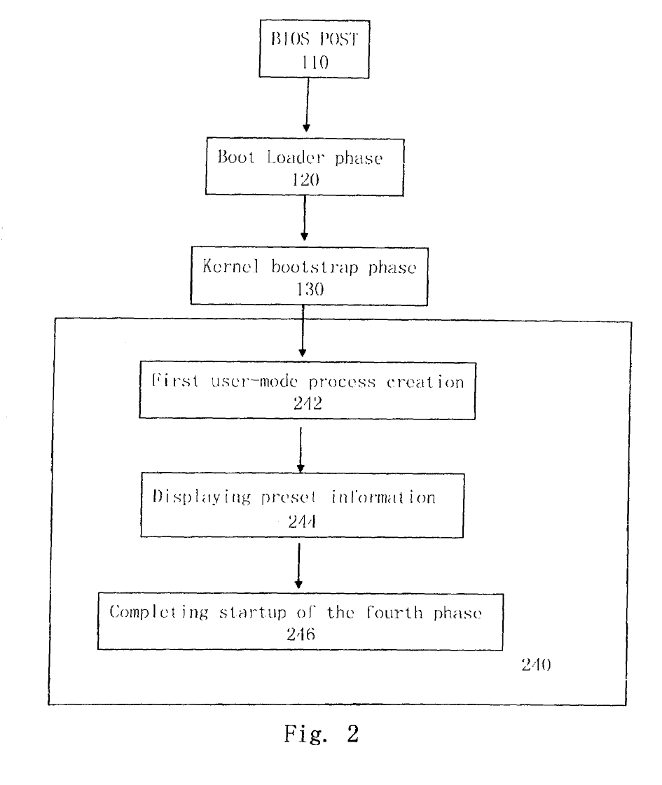

FIG. 2 is a flowchart according to another embodiment of the present invention. In the embodiment of FIG. 2, the first three steps 110, 120 and 130 are same to the corresponding steps in FIG. 1, and will not be illustrated for conciseness.

After step 130, the computer carries out the fourth phase step 240 of the operating system boot up. The fourth phase step 240 of the operating system boot up includes: a first user-mode process creation step 242, displaying preset information step 244, and completing startup step 246 of fourth phase 240. At step 242, the operating system kernel creates a first user-mode process. At step 244, the first user-mode process invokes user documents and display the user preset information. Wherein, the window system and graphic system of the computer operating system could be invoked to display the user preset information. At step 246, the computer will carry out other tasks for operating system boot up. Step 242 may include a step for loading window system for the operating system, and at step 244, the window system could be used for displaying the user preset information.

According to the above embodiment of the present invention, after the computer finishes the first three phases, the kernel is initialized, hardware drives and modules preset by the operating system are loaded, and the control of system is handed over to the first user-mode process created by the Kernel of the operating system. The first user-mode process for windows could be SMSS, and the first user-mode process for Linux could be init.

In Linux, the init process could be divided into 2 phases: SysInit phase and ServicesInit phase. For example, Linux execute/etc/rc.sysinit to enter SysInit phase, and create device files. Windows does not need this step. Then, driver modules are loaded. For Windows, this step is done in the above Kernel bootstrap phase 130. Then, the user preset information could be displayed.

When the user preset information is to be displayed, window system could be loaded first, e.g. win32k.sys for Windows and X window for Linux. Then, the required information is displayed according to the preset configuration. As an alternative, the preset configuration file could call window system and display the required information. Information in simple pure text format could be displayed similarly to command line of operating system.

At last, boot up process enters ServiceInit Phase. ServiceInit is SCM (Service Control Manager) for Windows and /etc/rc.d/rc for Linux. At this phase, various services are started. After starting these services, the display of the preset information could be ended. Then, the operating system displays login window to the user, so as to enable the user to login to the operating system. For example, Windows uses WINLOGON.EXE to prompt a user to login; Linux use Getty to prompt a user to login. A person skilled in the art could understand that the display of the preset information could be ended at any time after the services are started or even before the services completed starting, e.g. after a user login to the operating system.

According to a preferred embodiment of the present invention, displaying the present information would better be carried out before starting services. Thus, the user can utilize the information when the operating system is starting services.

For the information to be displayed, a user may use a script to automatically read information in the To Do list, information in the Calendar of Lotus Notes, or information in other applications. Thus, a user document for displaying the user preset information could be created. Then, next time the computer is booted up, this information could be displayed in the step for displaying preset information step (144 or 244).

Corresponding to the above method, the present invention also provides a computer for displaying user preset information, including: power on self test means, for powering on the computer, and enabling the computer to execute basic input output system power on self test; boot loader means, for executing boot loader started by an operating system to load the kernel of the operating system to the computer; kernel bootstrap means, for performing kernel bootstrap started by the operating system; startup section means, for the kernel of the operating system starting the startup section of the fourth phase of the operating system boot up process; displaying means, for displaying user preset information; and means for completing the fourth phase of the operating system boot up process.

Wherein the startup section means is further configured to create a first user mode process with said kernel; said displaying means is further configured to display user preset information with said first user mode process invoking a user document. The means for completing the fourth phase of the operating system boot up process further includes means for startup services. The computer further includes means for promoting a user to login the operating system after startup services.

Wherein the startup section means is further configured to loading window system for the operating system, and the displaying means uses the window system to display the user preset information. As an alternative, the displaying means is further configured to display the user preset information by invoking a window system of the operating system.

Wherein the operating system could be Linux operating system and the first user mode process created by the kernel is init. The operating system could be Windows operating system and the first user mode process created by the kernel is SMSS. The user preset information includes, but not limited to, the to do list, calendar information, pure text information or graphic information.

The present invention also provides a storage medium or signal carrier including instructions for carrying out the method of the present invention.

The preferred embodiments of the present invention have been described in detail. However, one skilled in the art will realize that the preferred embodiments are only given for the purpose of illustration, and should not be construed as limiting the preset invention thereto. This invention can be implemented by way of software, hardware or the combination of the two. One skilled in the art can make various modifications and variations to the present invention, however, these modifications and variations are all within the scope and spirit of the invention as defined in the accompanying claims.

1. A method for a computer displaying user preset information, comprising:
a) powering on the computer, and the computer executing basic input output system power on self test;
b) executing boot loader started by an operating system to load a kernel of the operating system to the computer;
c) performing kernel bootstrap started by the operating system;
d) the kernel of the operating system starting startup section of fourth phase of the operating system boot up process;
e) the computer displaying user preset information; and
f) completing the fourth phase of the operating system boot up process.

2. The method according to claim 1, wherein the step of the kernel of the operating system starting the starting up section of the fourth phase, further comprises said kernel creating a first user mode process; and the step of the computer displaying user preset information comprises the first user mode process invoking a user document and displaying user preset information.

3. The method according to claim 1, wherein the step of completing the fourth phase comprises startup services.

4. The method according to claim 3 further comprises promoting a user to login to the operating system after startup services.

5. The method according to claim 1, wherein the step of the kernel of the operating system starting the startup section of the fourth phase, further comprises loading window system for the operating system, and the step of displaying user preset information comprises using the window system to display the user preset information.

6. The method according to claim 1, wherein the step of displaying user preset information comprises invoking a window system of the operating system to display the user preset information.

7. The method according to claim 2, wherein the operating system is Linux operating system and the first user mode process created by the kernel is init.

8. The method according to claim 2, wherein the operating system is Windows operating system and the first user mode process created by the kernel is SMSS.

9. The method according to claim 1, wherein the user preset information comprises to do list, calendar information, pure text information or graphic information.

10. A computer for displaying user preset information, comprising:
power on self test means, for powering on the computer, and then enabling the computer to execute basic input output system power on self test;
boot loader means, for executing boot loader started by an operating system to load a kernel of the operating system to the computer;
kernel bootstrap means, for performing kernel bootstrap started by the operating system;
startup section means, for using the kernel of the operating system to start the startup section of fourth phase of the operating system boot up process;
displaying means, for displaying user preset information; and
means for completing the fourth phase of the operating system boot up process.

11. The computer according to claim 10, wherein said startup section means is further configured to create a first user mode process with said kernel; said displaying means is further configured to invoke a user document and display user preset information with said first user mode process.

12. The computer according to claim 10, wherein means for completing the fourth phase of the operating system boot up process further comprises means for startup services.

13. The computer according to claim 12 further comprises means for promoting a user to login to the operating system after startup services.

14. The computer according to claim 10, wherein said startup section means is further configured to load window system for the operating system, and said displaying means uses the window system to display the user preset information.

15. The computer according to claim 10, wherein said displaying means is further configured to display the user preset information by invoking a window system of the operating system.

16. The computer according to claim 11, wherein the operating system is Linux operating system and the first user mode process created by the kernel is init.

17. The computer according to claim 11, wherein the operating system is Windows operating system and the first user mode process created by the kernel is SMSS.

18. The computer according to claim 10, wherein the user preset information comprises to do list, calendar information, pure text information or graphic information.

19. A storage medium or signal carrier, comprising instructions for carrying out a method for a computer displaying user preset information, comprising:
a) powering on the computer, and the computer executing basic input output system power on self test;
b) executing boot loader started by an operating system to load a kernel of the operating system to the computer;
c) performing kernel bootstrap started by the operating system;
d) the kernel of the operating system starting startup section of fourth phase of the operating system boot up process;
e) the computer displaying user preset information; and
f) completing the fourth phase of the operating system boot up process.
